(19) United States
(12) Patent Application Publication
(10) Pub. No.: US 2017/0149917 A1
(43) Pub. Date: May 25, 2017

(54) INFORMATION COMMUNICATION METHODS, APPARATUSES AND SYSTEMS

(71) Applicant: Beijing Zhigu Rui Tuo Tech Co., Ltd, Beijing (CN)

(72) Inventor: Jia LIU, Beijing (CN)

(21) Appl. No.: 15/320,748

(22) PCT Filed: Jun. 5, 2015
(86) PCT No.: PCT/CN2015/080837

§ 371 Date: Dec. 20, 2016

(30) Foreign Application Priority Data
Jun. 25, 2014 (CN) 201410295001.3

(51) Int. Cl. H04L 29/08; G06F 17/30

(52) U.S. Cl. CPC H04L 67/26; G06F 17/30867; G06F 17/3087

(57) ABSTRACT

Information communication methods, apparatuses and systems are described, wherein the information communication method comprises: acquiring scenario description information, regularity information of execution of a terminal application and intent data of execution of the terminal application; and sending the acquired intent data to a terminal in a situation that the scenario description information matches corresponding information in the regularity information. Tedious operations performed by users for acquiring intent data can be simplified or eliminated, the intent data can be provided targetedly according to different scenario description information and regularity information of execution of different applications, demands of the users can be better met, and user experience as well as timeliness are improved.

### RELATED APPLICATION

The present international patent cooperative treaty (PCT) application claims the benefit of priority to Chinese Patent Application No. 201410295001.3, filed on Jun. 25, 2014, and entitled “Information Communication Method, Apparatus and System”, which is hereby incorporated into the present international PCT application by reference herein in its entirety.

### TECHNICAL FIELD

The present application relates to the field of information communication technologies, and in particular, to information communication methods, apparatuses and systems.

### BACKGROUND

Networks are filled with open and diverse mass information, and network-based information acquisition has become a main manner of acquiring information by users in network era.

There are generally two manners of acquiring information by users based on the network. One is a manner of actively acquiring information by the users, for example, a user executes certain application software on a terminal to connect to a server, and actively acquires information data in which the user is interested from the server. The other is a manner of passively acquiring information by the users, for example, a user receives information data actively pushed by a server through a terminal.

No matter which information acquisition manner is adopted, the manner is intended to make the users acquire information more conveniently and efficiently, thus attracting more and more researchers to pay high attention to innovative technologies of information communication.

### SUMMARY

A brief summary about the present application is given hereinafter, so as to provide a basic understanding about certain aspects of the present application. It should be understood that the summary is not an exhaustive summary about the present application. It is neither intended to determine critical or important parts of the present application, nor intended to limit the scope of the present application. Its purpose is merely giving some concepts in a simplified form, to be taken as the preamble to be described later in more detail.

The present application provides information communication methods, apparatuses and systems.

In one aspect, example embodiments of the present application provide an information communication method, comprising:

acquiring scenario description information, regularity information of execution of a terminal application and intent data of execution of the terminal application; and

sending the acquired intent data to a terminal in a situation that the scenario description information matches corresponding information in the regularity information.

In another aspect, example embodiments of the present application further provide an information communication apparatus, comprising:

a scenario description information acquisition module, configured to acquire scenario description information;

a regularity information acquisition module, configured to acquire regularity information of execution of a terminal application;

an intent data acquisition module, configured to acquire intent data of execution of the terminal application; and

an information sending module, configured to send the intent data acquired by the intent data acquisition module to the terminal in a situation that the scenario description information acquired by the scenario description information acquisition module matches corresponding information in the regularity information acquired by the regularity information acquisition module.

In a further aspect, example embodiments of the present application provide an information communication system, comprising: a terminal and the information communication apparatus, the information communication apparatus being configured to provide intent data required by execution of the terminal application in a situation of being in a communication connection with the terminal.

Example technical solutions provided in one or more of the embodiments of the present application combine scenarios and regularity information of execution of terminal applications to intelligently send information, that is, the information communication apparatus acquires scenario description information, regularity information of execution of a terminal application and intent data of execution of the terminal application, and actively sends the intent data to a terminal in a situation that the scenario description information matches corresponding information in the regularity information, which thus simplifies or eliminates tedious operations performed by users for acquiring intent data, can provide the intent data targetedly according to different scenario description information and regularity information of execution of different applications, can better meet demands of the users, has good timeliness, and improves user experience.

These and/or other advantages of one or more example embodiments of the present application will be more evident through the following detailed description about alternative embodiments of the present application with reference to the accompanying drawings.

### BRIEF DESCRIPTION OF THE DRAWINGS

The present application can be better understood with reference to the description given below in combination with the accompanying drawings, in which the same or similar reference signs are used in all the drawings to indicate the same or similar components. The drawings together with the following detailed description are included in the specification and form a part of the specification, and are configured to further exemplify alternative embodiments of the present application and explain the principle and advantages of the present application. In the drawings:

FIG. 1 is a flowchart of one information communication method according to an example embodiment of the present application;

FIG. 2 is a flowchart of another information communication method according to an example embodiment of the present application;

FIG. 3 is a schematic structural diagram of a first information communication apparatus according to an example embodiment of the present application;

FIG. 4 is a schematic structural diagram of a second information communication apparatus according to an example embodiment of the present application;

FIG. 5 is a schematic structural diagram of a third information communication apparatus according to an example embodiment of the present application;

FIG. 6 is a schematic structural diagram of a fourth information communication apparatus according to an example embodiment of the present application;

FIG. 7 is a schematic structural diagram of a fifth information communication apparatus according to an example embodiment of the present application;

FIG. 8 is a schematic structural diagram of a sixth information communication apparatus according to an example embodiment of the present application;

FIG. 9 is a schematic structural diagram of a seventh information communication apparatus according to an example embodiment of the present application;

FIG. 10 is a schematic architectural diagram of one information communication system according to an example embodiment of the present application; and

FIG. 11 is a schematic architectural diagram of another information communication system according to an example embodiment of the present application.

Those skilled in the art should understand that, elements in the drawings are merely illustrated for the sake of simplicity and clarity, and may not be drawn to scale. For example, sizes of certain elements in the drawings may be amplified relative to other elements, so as to help to improve the understanding about the embodiments of the present application.

### DETAILED DESCRIPTION

Example embodiments of the present application are described below in detail with reference to the accompanying drawings. For the sake of clarity and simplicity, not all the features of the example embodiments have to be described in the specification. However, it should be understood that, lots of decisions specific to implementations can be made during development of any such actual embodiment, so as to achieve specific goals of developers, for example, restrictions relevant to systems and services are met, and the restrictions may vary with different embodiments. In addition, it should also be understood that, although development work is likely to be complicated and time-consuming, for those skilled in the art who benefit from the disclosure, the development work is merely a routine task.

Herein, it should also be noted that, in order to avoid blurring the present application due to unnecessary details, only apparatus structures and/or processing steps closely related to solutions according to the present application are described in the accompanying drawings and the specification, but representation and description about members and processing having little to do with the present application and known to those of ordinary skill in the art are omitted.

Example embodiments of the present application are described in detail hereinafter with reference to the accompanying drawings and embodiments (in which the same elements are denoted by the same reference numerals). The following embodiments are intended to describe the present application, but not to limit the scope of the present application.

It should be understood by those skilled in the art that the terms such as “first” and “second” are merely intended to distinguish different steps, devices or modules, etc., which neither represent any particular technical meaning nor indicate a necessary logical sequence between them.

FIG. 1 is a flowchart of one information communication method according to an embodiment of the present application. An execution body of the information communication method according to the embodiment of the present application is a certain information communication apparatus, and the information communication apparatus may be, but is not limited to, communication devices serving as intermediate nodes or background devices, wherein the intermediate nodes may be, but are not limited to, gateways, access points and the like, and the background devices may be, but are not limited to, service clusters, cloud servers, third-party device operating platforms and the like. The term “serve as . . . ” herein is generally in terms of a function of an apparatus, instead of limiting a specific device entity manifestation of the apparatus, for example, if a certain terminal seems to be different from the traditional gateway or access point device in terms of a device entity manifestation, but the terminal at least partially serves as a gateway or hotspot access device, the terminal also belongs to the information communication apparatus of the present application, which is not limited in the present application. Specifically, as shown in FIG. 1, the information communication method according to the embodiment of the present application comprises:

S101: Acquire scenario description information, regularity information of execution of a terminal application and intent data of execution of the terminal application.

The scenario description information comprises: one or more elements configured to describe a certain scenario, and the elements may be, but are not limited to, the following information: time, place, characters and event, for example, a user A (uses a terminal B) is always waiting for the elevator at the door at 8:00 a.m.

The regularity information of execution of a terminal application comprises: configured to describe one or more information having regularity obtained based on statistics on information of execution of a terminal application (APP for short). The information of execution of the terminal application comprises, but is not limited to: configured to describe one or more information related to terminal-executing application attributes, execution behaviors or environments, and the information may comprise, but is not limited to: terminal-executing application characteristic information, time when a terminal executes an application, environment description, communication interaction and other information, wherein the environment description information comprises, but is not limited to, information of location of the terminal and the like, and the information of location of the terminal may be implemented by using an indoor positioning technology based on terminal signal strength, based on an Angle of Arrival (AoA for short) or the like or by using a positioning technology such as a Global Positioning System (GPS for short), which is not limited in the present application; the communication interaction information may comprise, but is not limited to, a data message sent by the terminal, intent data received and the like. The information having regularity obtained based on statistics on information of execution of a terminal-executing application may specifically comprise, but is not limited to, one or more of the following information: terminal-executing application, time, place and the type of intent data, for example, a terminal B is always executing an application C at 8:00 a.m. to make a request for acquiring data of weather conditions.

The intent data of execution of the terminal application comprises: configured to describe one or more types of data that the terminal usually makes a request for acquiring when executing the application, and the data is usually data that a user desires to obtain when running the application on the terminal, for example, data of weather conditions that a user A makes a request for acquiring when executing an application C on a terminal B.

S102: Send the acquired intent data to a terminal in a situation that the scenario description information matches corresponding information in the regularity information.

The expression “matches corresponding information” in “the scenario description information matches corresponding information in the regularity information” means that: the scenario description information matches the same type of information comprised in the regularity information. For example, the scenario description information comprises time information, the regularity information also comprises time information, if the two kinds of time information are the same or the former falls within the time period determined by the latter, it indicates that they match each other, and the like.

As types of terminal applications are unceasingly rich and popular, executing applications on terminals to acquire information is an information acquisition manner commonly adopted by terminal users. It is noted that: if there is a request to obtain the data, the users can open the applications on the terminals, generally a number of steps are executed, and then the terminals can be controlled to obtain data that the users desire to obtain; however, operations are more tedious, and user experience is poor. Alternatively, the background device may also actively push information based on pre-customization, but such a pushing manner is often out of line with dynamic user demands, and has poor timeliness. Practice shows that the manners in which many users acquire information based on terminal applications will often present certain regularity, for example, a certain user will open a certain terminal application in a certain scenario to obtain data that he/her wishes to obtain. Therefore, if scenarios and regularity information of execution of terminal applications are combined to intelligently send information, user information will be acquired more conveniently, the data sent will be more consistent with user demands, and timeliness is higher.

To this end, according to the technical solution in this embodiment, an information communication apparatus acquires scenario description information, regularity information of execution of a terminal application and intent data of execution of the terminal application, performs matching analysis on the scenario description information and the regularity information, and actively sends the intent data to a terminal in a situation that their corresponding information matches each other, for example, in a certain time period, when a terminal is located in a certain particular position, intent data during execution of a certain application of the terminal is sent to the terminal; the solution simplifies or eliminates tedious operations performed by users for acquiring intent data, can targetedly provide the intent data according to different scenario description information and regularity information of execution of different applications, can better meet demands of the users, has good timeliness, and improves user experience.

The technical solution in the present application does not limit the specific manner in which the information communication apparatus acquires the regularity information of execution of the terminal application, and example embodiments are flexible.

For example, an external device may make a statistics on regularity information of execution of a terminal application, and the information communication apparatus acquires the regularity information from the external device. The “external device” in the present application may be other devices except the information communication apparatus, the external device and the information communication apparatus may be located in the same local area network (LAN), or located in different LANs, or the external device and the information communication apparatus communicate based on a wide area network (WAN), and the like, which is not limited in the present application. The solution that the information communication apparatus acquires the regularity information from the external device can reduce the burden of the information communication apparatus, and achieves sharing of the regularity information.

For another example, the information communication apparatus can obtain the regularity information through self-learning. The information communication apparatus can make a statistics on information of execution of the terminal application, and acquires the regularity information according to statistical results. The solution is that the information communication apparatus obtains the regularity information through statistical analysis on the information of execution of the terminal application during a direct communication connection with the terminal, therefore, the implementation is simpler, and the acquired regularity information is more accurate; in addition, targeted sending of corresponding intent data may also be adjusted according to dynamic changes of execution of user terminal applications, so as to better meet dynamic user demands, thereby improving user experience. In one example embodiment, during learning of the information communication apparatus, the information of execution of the terminal application comprises: receiving a data message sent by the terminal and configured to acquire the intent data of execution of the terminal application; and making a statistics on the information of execution according to the data message. As the data message sent by the terminal during application execution usually carries characteristic fields configured to indicate the application, time information of execution of the application and the like, statistics on the information of execution based on the data message is a simple method and easy to implement.

In one example embodiment, the regularity information of execution of the terminal application comprises at least one of the following: time information of execution of the terminal application, and position information of the terminal during execution of the terminal application. Statistics on the time information and the position information in the solution, relative to other information, can better embody regularity of execution of the terminal application and has small errors.

In one example embodiment, the scenario description information comprises at least one of the following: current time information, and current position information of the terminal. The time information and the position information in the solution are easy for statistics, can better describe a scenario relative to other information, and have small errors.

After acquiring the scenario description information and the regularity information, the information communication apparatus can perform matching analysis on their corresponding information.

For example, the scenario description information comprises current time information A, the regularity information comprises time information B of execution of the terminal application, the information communication apparatus judges whether A and B match each other, for example, judges whether A is within the time period limited by B, if yes, they match each other, and otherwise, they do not match each other.

For another example, the scenario description information comprises current position information C of the terminal, the regularity information comprises position information D of the terminal during execution of the terminal application, the information communication apparatus judges whether C and D match each other, for example, whether C is within a regional scope limited by D, if yes, they match each other, and otherwise, they do not match each other.

For another example, the scenario description information comprises current time information A and current position information C of the terminal, the regularity information comprises time information B of execution of the terminal application and position information D of the terminal during execution of the terminal application, the information communication apparatus judges whether A and B match each other and whether C and D match each other, if yes, they match each other, and otherwise, they do not match each other.

The information communication apparatus sends the acquired intent data to the terminal in a situation that the scenario description information matches corresponding information in the regularity information.

The technical solution in the present application does not limit the specific manner in which the information communication apparatus acquires the intent data of execution of the terminal application, and example embodiments are flexible.

For example, the information communication apparatus may acquire the intent data of execution of the terminal application from an external device, in this situation, an information source of the intent data acquired by the information communication apparatus is a non-local information source or remote information source, the non-local information source or remote information source may be the same as or different from an actual information source of the intent data acquired by the terminal during execution of the application, example embodiments are flexible, and the user demand for acquiring the intent data may also be met.

For another example, the information communication apparatus may also determine an information source of the intent data of execution of the terminal application, and acquires the intent data from the information source. The information source may be a remote information source or non-local information source, or the information source may also be a non-remote information source or local information source, the situation of the non-remote information source or local information source is: for example, the intent data is temperature data, and if the information communication apparatus is provided thereon with a sensor array collecting air temperatures, a temperature collecting result of the sensor array is the non-remote information source or local information source of the intent data. In this situation, the information source of the intent data acquired by the information communication apparatus is the same as the actual information source of the intent data acquired by the terminal during execution of the application, thus improving user experience. In addition, the manner in which the information communication apparatus determines the information source of the intent data of execution of the terminal application is also very flexible; in one example embodiment, the information communication apparatus receives a data message sent by the terminal and configured to acquire the intent data of execution of the terminal application; and obtains the information source of the intent data obtained by the terminal according to the data message. As the data message sent by the terminal during application execution usually carries relevant information configured to make a request for acquiring a target address or other information sources of the intent data, determining the information source based on the data message is a simple method and easy to implement.

In the technical solution of the present application, the time at which the information communication apparatus acquires the intent data of execution of the terminal application is also very flexible.

For example, the information communication apparatus may acquire the intent data in a situation that the scenario description information matches corresponding information in the regularity information of execution of the terminal application.

For another example, the information communication apparatus first acquires the intent data at a convenient time, and when determining that the scenario description information matches corresponding information in the regularity information of execution of the terminal application, sends the intent data to the terminal. The solution can flexibly determine acquisition time of the intent data according to a busy or idle state of the information communication apparatus, and the information communication apparatus can timely send matching data to the terminal in a situation that the scenario description information matches corresponding information in the regularity information of execution of the terminal application, which has little delay and even no delay. In terms of information communication apparatuses that remain in a network connection state all the time or for a long time, the solution is more convenient and easy to implement. For example, for information communication devices like intermediate nodes such as home gateways, during actual use, the home gateways are in a power-on state and remain in a network connection, the home gateways can determine the time of acquiring the intent data according to actual requirements, and example embodiments are flexible.

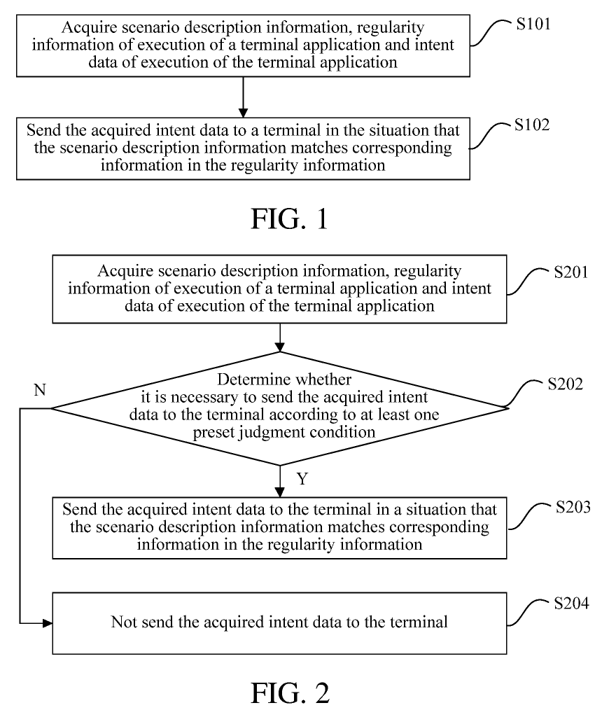

FIG. 2 is a flowchart of another information communication method according to an embodiment of the present application. As shown in FIG. 2, different from the foregoing method embodiment, the information communication method according to this embodiment further comprises: the information communication apparatus determines whether to send the acquired intent data to the terminal according to a preset judgment condition before sending the acquired intent data to the terminal. Specifically, as shown in FIG. 2, the information communication method according to this embodiment comprises:

S201: Acquire scenario description information, regularity information of execution of a terminal application and intent data of execution of the terminal application.

S202: Determine whether to send the acquired intent data to the terminal according to at least one preset judgment condition, if yes, perform S203, and otherwise, perform S204.

S203: Send the acquired intent data to the terminal in a situation that the scenario description information matches corresponding information in the regularity information.

S204: Not send the acquired intent data to the terminal.

The technical solution according to this embodiment may also achieve the technical effect of the foregoing method embodiment; in addition, according to the technical solution in this embodiment, the information communication apparatus may determine whether to send the acquired intent data to the terminal according to a preset judgment condition, and send or not send the acquired intent data to the terminal according to a judgment result, to cause sending of the intent data to be more targeted, thereby reducing interference possibly brought about to terminal users due to non-matching between the intent data and user demands and further improving user experience.

The preset judgment condition may be set according to actual demands of the terminal users, which is not limited in the present application.

In one example embodiment, the preset judgment condition comprises: whether the intent data satisfies a pre-customized data filter condition. In this situation, after acquiring the intent data, the information communication apparatus first performs matching judgment on the intent data and the pre-customized data filter condition, if the data filter condition is met, S203 is performed, and otherwise, S204 is performed. The pre-customized data filter condition may also be set according to actual requirements of terminal users. For example, suppose that the intent data is data of weather conditions, and the terminal users pay no attention to general weather conditions but pay more attention to special weather conditions, for example, rain, fog, snow or high temperature weathers, correspondingly, the users may customize a data filter condition according to attention information. The information communication apparatus sends the intent data to the terminal only when the acquired intent data meets the data filter condition. The solution is highly consistent with the actual user demand, thereby achieving intelligent sending of the intent data and further improving user experience.

In another example embodiment, the preset judgment condition comprises: whether the terminal is currently in a preset call state. In this situation, the information communication apparatus first judges whether the terminal is currently in a preset call state after acquiring the intent data, if yes, S203 is performed, and otherwise, S204 is performed. The preset call state comprises a call connection state or a call idle state. In real life, user demands are diverse, some users hope to acquire intent data in a manner of actively acquiring information by the terminal in a call idle state (or called non-call connection state), do not hope that other parties except the terminal actively send the intent data to the terminal and do not hope that acquisition of the intent data is delayed due to the call connection; at this time, the users can customize to the information communication apparatus that the preset call state where the intent data can be sent is a call connection state, and the information communication apparatus sends the intent data to the terminal in a situation that the scenario description information matches corresponding information in the regularity information and the terminal is in a communication connection state. The solution can meet diverse demands, achieve intelligent sending of the intent data, and further improves user experience.

In another example embodiment, the preset judgment condition comprises: whether the intent data satisfies a pre-customized data filter condition, and whether the terminal is currently in a preset call state. In this situation, after acquiring the intent data, the information communication apparatus first performs matching judgment on the intent data and the pre-customized data filter condition and judges whether the terminal is currently in a preset call state, if the data filter condition is met and the terminal is currently in the preset call state, S203 is performed, and otherwise, S204 is performed. The solution can meet diverse demands, achieves intelligent sending of the intent data, and further improves user experience.

On the basis of the technical solution in any one of the foregoing method embodiments of the present application, the information communication method in the present application may further comprise: determining at least one other terminal associated with the terminal; and sending the intent data to the at least one other terminal. In one optional application scenario, for example, in a certain home network, the information communication apparatus sets terminals used by different family members as associated terminals, when a certain terminal is in a scenario corresponding to the scenario description information (for example, wait for the elevator at 8:00 a.m. at the door), acquires intent data such as data of weather conditions sent by an information pushing apparatus to the terminal, and also sends the intent data to other terminals associated with the terminal. The solution can achieve that a plurality of associated terminals shares the intent data and eliminate tedious operations of acquiring the intent data repeatedly by other terminals.

On the basis of the technical solution in any one of the foregoing method embodiments of the present application, the information communication method in the present application may further comprise: determining characteristic information of the terminal application; and sending the characteristic information of the terminal application to the terminal. The present application does not limit the way in which the information communication apparatus acquires characteristic information of the terminal application. In one example embodiment, the information communication apparatus may acquire characteristic information of the terminal application according to a received data message sent by the terminal and configured to acquire the intent data of execution of the terminal application, and also sends the characteristic information of the terminal application to the terminal while sending the intent data to the terminal. The advantage of such processing is that, after receiving the information sent by the information communication apparatus, the terminal may call a software program of an application on the terminal matching the characteristic information according to the characteristic information, to present the intent data by running the software program, and as the terminal uses a software program of an application to present the intent data, the presentation manner is the same as or most similar to the manner in which the terminal opens an application to acquire the intent data, and the user can operate functions supported by the application without opening the application once again, which further facilitates user operations. Certainly, the manner of presenting the intent data on the terminal is very flexible, and may comprise, but is not limited to, various manners such as full content display, local content display, key information prompt and new information prompt, which is not limited in the present application. In addition, the way in which the information communication apparatus sends the intent data and the characteristic information of the terminal application to the terminal is also very flexible, for example, the information communication apparatus may carry the intent data and the characteristic information of the terminal application in the same data packet to be sent to the terminal, or, the information communication apparatus may also take the two kinds of information as different data packets to be sent to the terminal respectively, or the like, which is not limited in the present application.

It should be understood by those skilled in the art that, in any one of the foregoing methods of the example embodiments of the present application, the value of the serial number of each step described above does not mean an execution sequence, and the execution sequence of each step should be determined according to the function and internal logic thereof, and should not be any limitation to the example embodiments of the present application. In addition, even if a plurality of information acquired is described in the serial number of a certain step, it does not mean that the information is acquired synchronously, for example, a sequence of acquiring scenario description information, regularity information of execution of a terminal application and intent data of execution of the terminal application described in S101 and S201 should also be determined according to the function and internal logic thereof, and should not be any limitation to the example embodiments of the present application.

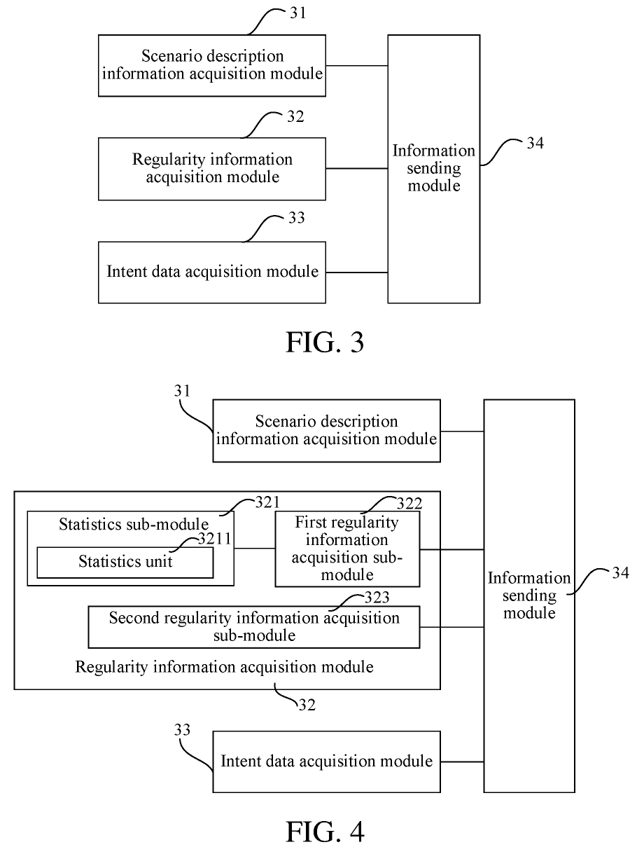

FIG. 3 is a schematic structural diagram of a first information communication apparatus according to an embodiment of the present application. As shown in FIG. 3, the information communication apparatus according to this embodiment of the present application comprises: a scenario description information acquisition module 31, a regularity information acquisition module 32, an intent data acquisition module 33 and an information sending module 34.

The scenario description information acquisition module 31 is configured to acquire scenario description information.

The regularity information acquisition module 32 is configured to acquire regularity information of execution of a terminal application.

The intent data acquisition module 33 is configured to acquire intent data of execution of the terminal application.

The information sending module 34 is configured to send the intent data acquired by the intent data acquisition module 33 to the terminal in a situation that the scenario description information acquired by the scenario description information acquisition module 31 matches corresponding information in the regularity information acquired by the regularity information acquisition module 32.

The information communication apparatus in this embodiment acquires scenario description information, regularity information of execution of a terminal application and intent data of execution of the terminal application, performs matching analysis on the scenario description information and the regularity information, and actively sends the intent data to a terminal in a situation that their corresponding information matches each other, which thus simplifies or eliminates tedious operations performed by users for acquiring intent data, can targetedly provide the intent data according to different scenario description information and regularity information of execution of different applications, can better meet demands of the users, has good timeliness, and improves user experience.

The information communication apparatus according to this embodiment of the present application may be, but is not limited to, communication devices serving as intermediate nodes or background devices, wherein the intermediate nodes may be, but are not limited to, gateways, access points and the like, and the background devices may be, but are not limited to, service clusters, cloud servers, third-party device operating platforms and the like. The term “serve as . . . ” herein is generally in terms of a function of an apparatus, instead of limiting a specific device entity manifestation of the apparatus, for example, if a certain terminal seems to be different from the traditional gateway or access point device in terms of a device entity manifestation, but the terminal at least partially serves as a gateway or hotspot access device, the terminal also belongs to the information communication apparatus of the present application, which is not limited in the present application.

Optionally, the regularity information of execution of the terminal application acquired by the regularity information acquisition module 32 comprises at least one of the following: time information of execution of the terminal application, and position information of the terminal during execution of the terminal application. Statistics on the time information and the position information in the solution, relative to other information, can better embody regularity of execution of the terminal application and has small errors.

Optionally, the scenario description information acquired by the scenario description information acquisition module 31 comprises at least one of the following: current time information, and current position information of the terminal. The time information and the position information in the solution are easy for statistics, can better describe a scenario relative to other information, and have small errors.

In one example embodiment, the information communication apparatus can obtain the regularity information through self-learning. In this situation, as shown in FIG. 4, the regularity information acquisition module 32 comprises: a statistics sub-module 321 and a first regularity information acquisition sub-module 322. The statistics sub-module 321 is configured to make a statistics on information of execution of the terminal application. The first regularity information acquisition sub-module 322 is configured to acquire the regularity information according to statistical results of the statistics sub-module 321. The solution is that the information communication apparatus obtains the regularity information through statistical analysis on the information of execution of the terminal application during a direct communication connection with the terminal, therefore, the implementation is simpler, and the acquired regularity information is more accurate; in addition, targeted sending of corresponding intent data may also be adjusted according to dynamic changes of execution of user terminal applications, so as to better meet dynamic user demands, thereby improving user experience.

Further, the statistics sub-module 321 may comprise: a statistics unit 3211. The statistics unit 3211 is configured to make a statistics on the information of execution according to a received data message sent by the terminal and configured to acquire the intent data of execution of the terminal application. As the data message sent by the terminal during application execution usually carries characteristic fields configured to indicate the application, time information of execution of the application and the like, statistics on the information of execution based on the data message is a simple method and easy to implement.

In another example embodiment, the regularity information acquisition module 32 may comprise: a second regularity information acquisition sub-module 323. The second regularity information acquisition sub-module 323 is configured to acquire the regularity information from an external device. The solution can reduce the burden of the information communication apparatus, and achieves sharing of the regularity information.

The time at which the intent data acquisition module 33 acquires the intent data of execution of the terminal application is very flexible. For example, the intent data acquisition module 33 may acquire the intent data in a situation that the scenario description information matches corresponding information in the regularity information; or the intent data acquisition module 33 may determine other suitable time for acquiring the intent data according to actual requirements to acquire the intent data.

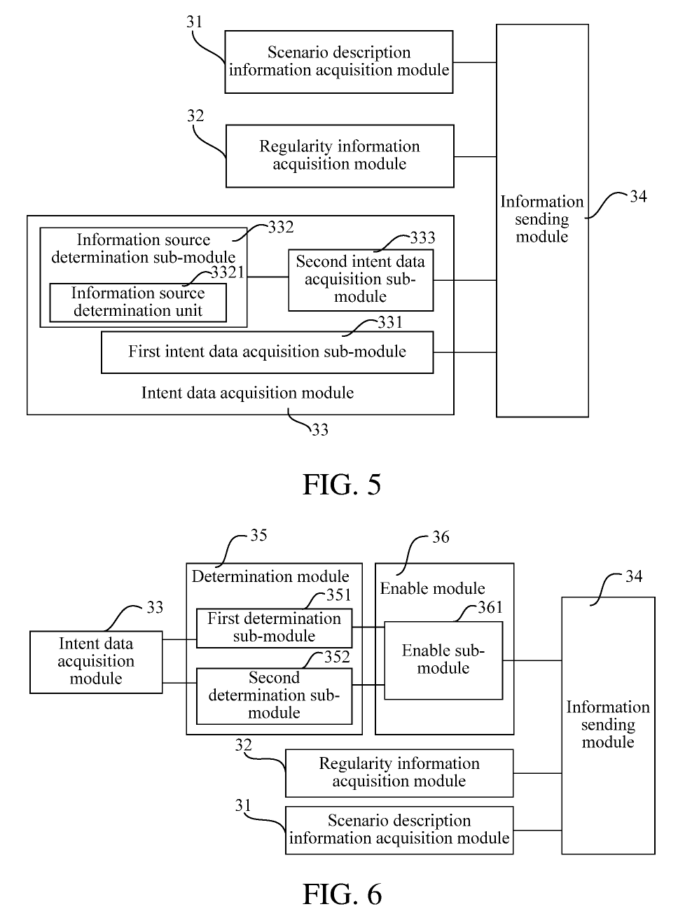

In one example embodiment, as shown in FIG. 5, the intent data acquisition module 33 comprises a first intent data acquisition sub-module 331. The first intent data acquisition sub-module 331 is configured to acquire the intent data of execution of the terminal application from an external device. In this situation, an information source of the intent data acquired by the information communication apparatus is a remote information source or non-local information source, the remote information source or non-local information source may be the same as or different from an actual information source of the intent data acquired by the terminal during execution of the application, example embodiments are flexible, and the user demand for acquiring the intent data may also be met.

In another example embodiment, the intent data acquisition module 33 comprises: an information source determination sub-module 332 and a second intent data acquisition sub-module 333. The information source determination sub-module 332 is configured to determine an information source of the intent data of execution of the terminal application. The second intent data acquisition sub-module 333 is configured to acquire the intent data from the information source determined by the information source determination sub-module. The information source may be a remote information source or non-local information source, or the information source may also be a non-remote information source or local information source. By use of the solution, the information source of the intent data acquired by the information communication apparatus is the same as the actual information source of the intent data acquired by the terminal during execution of the application, thus improving user experience.

Further, the information source determination sub-module 332 may comprise: an information source determination unit 3321. The information source determination unit 3321 is configured to obtain the information source of the intent data obtained by the terminal according to a received data message sent by the terminal and configured to acquire the intent data of execution of the terminal application. The solution is simple and easy to implement.

On the basis of the technical solution of any one of the foregoing information communication apparatus embodiments, as shown in FIG. 6, the information communication apparatus may further comprise: a determination module 35 and an enable module 36. The determination module 35 is configured to determine whether to send the acquired intent data to the terminal according to at least one preset judgment condition. The enable module 36 is configured to enable the information sending module according to a determination result of the determination module. The solution causes sending of the intent data to be more targeted, thereby reducing interference possibly brought about to terminal users due to non-matching between the intent data and user demands and further improving user experience.

Further, the determination module 35 comprises at least one of the following: a first determination sub-module 351 and a second determination sub-module 352. Correspondingly, the enable module 36 comprises an enable sub-module 361, and the enable sub-module 361 is configured to enable the information sending module 34 according to a judgment result of the first determination sub-module 351 and/or the second determination sub-module 352.

For example, the determination module 35 comprises a first determination sub-module 351. The first determination sub-module 351 is configured to determine whether the intent data acquired by the intent data acquisition module 33 satisfies a pre-customized data filter condition. In this situation, the enable sub-module 361 is configured to enable the information sending module 34 according to a judgment result of the first determination sub-module 351. Specifically, if the first determination sub-module 351 determines that the intent data acquired by the intent data acquisition module 33 satisfies the pre-customized data filter condition, the enable sub-module 361 enables the information sending module 34, to cause the information sending module 34 to send the intent data to the terminal; and otherwise, the enable sub-module 361 does not enable the information sending module 34, and the information sending module 34 will not send the intent data to the terminal.

For another example, the determination module 35 comprises a second determination sub-module 352. The second determination sub-module 352 is configured to determine whether the terminal is currently in a preset call state. In this situation, the enable sub-module 361 is configured to enable the information sending module 34 according to a judgment result of the second determination sub-module 352. Specifically, if the second determination sub-module determines that the terminal is currently in the preset call state in a situation that the scenario description information matches corresponding information in the regularity information of execution of the terminal application, the enable sub-module 361 enables the information sending module 34, to cause the information sending module 34 to send the intent data to the terminal; and otherwise, the enable sub-module 361 does not enable the information sending module 34, and the information sending module 34 will not send the intent data to the terminal. The solution is highly consistent with the actual user demand, thereby achieving intelligent sending of the intent data and further improving user experience. The solution can meet diverse demands, achieves intelligent sending of the intent data, and further improves user experience.

For another example, the determination module 35 comprises a first determination sub-module 351 and a second determination sub-module 352. In this situation, the enable sub-module 361 is configured to enable the information sending module 34 according to judgment results of the first determination sub-module 351 and the second determination sub-module 352. Specifically, if the first determination sub-module determines that the intent data acquired by the intent data acquisition module 33 satisfies the pre-customized data filter condition and the second determination sub-module determines that the terminal is currently in the preset call state in a situation that the scenario description information matches corresponding information in the regularity information of execution of the terminal application, the enable sub-module 361 enables the information sending module 34, to cause the information sending module 34 to send the intent data to the terminal; and otherwise, the enable sub-module 361 does not enable the information sending module 34, and the information sending module 34 will not send the intent data to the terminal. The solution can meet diverse demands, achieves intelligent sending of the intent data, and further improves user experience.

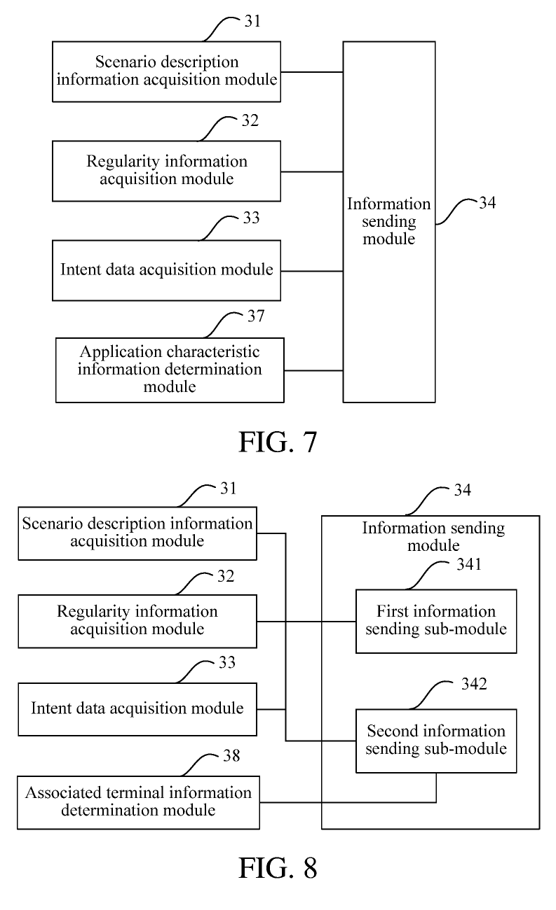

On the basis of the technical solution of any one of the foregoing information communication apparatus embodiments, as shown in FIG. 7, the information communication apparatus further comprises: an application characteristic information determination module 37. The application characteristic information determination module 37 is configured to determine characteristic information of the terminal application. Correspondingly, the information sending module 34 sends the characteristic information of the terminal application to the terminal. The solution enables the terminal, after receiving the intent data and the characteristic information sent by the information communication apparatus, to call a software program of an application on the terminal matching the characteristic information according to the characteristic information, to present the intent data by running the software program, and as the terminal uses a software program of an application to present the intent data, the presentation manner is the same as or most similar to the manner in which the terminal opens an application to acquire the intent data, and the user can operate functions supported by the application without opening the application once again, which further facilitates user operations.

On the basis of the technical solution of any one of the foregoing information communication apparatus embodiments, as shown in FIG. 8, the information communication apparatus further comprises: an associated terminal information determination module 38; the associated terminal information determination module 38 is configured to determine at least one other terminal associated with the terminal. Correspondingly, the information sending module 34 comprises: a first information sending sub-module 341 and a second information sending sub-module 342. The first information sending sub-module 341 is configured to send the intent data to the terminal in a situation that the scenario description information matches corresponding information in the regularity information. The second information sending sub-module 342 is configured to send the intent data to the at least one other terminal determined by the associated terminal information determination module 38 in a situation that the scenario description information matches corresponding information in the regularity information. The solution can achieve that a plurality of associated terminals share the intent data and eliminate tedious operations of acquiring the intent data repeatedly by other terminals.

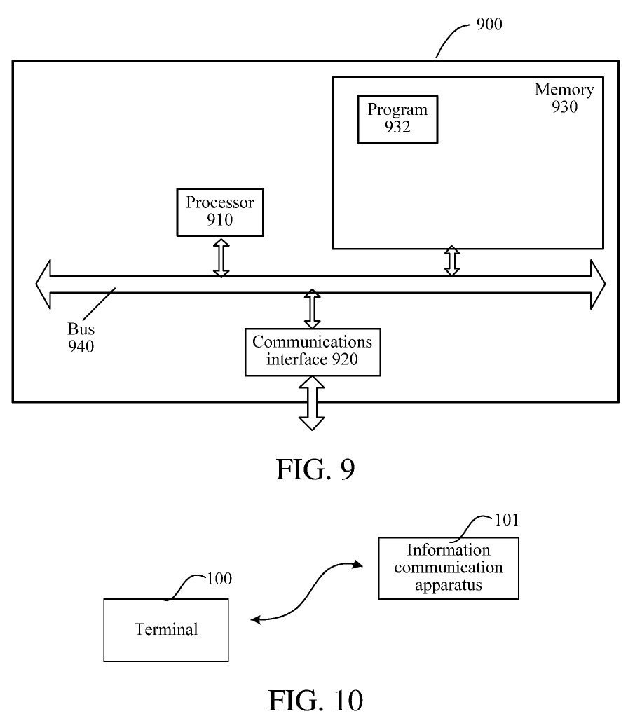

FIG. 9 is a schematic structural diagram of a seventh information communication apparatus according to an embodiment of the present application; the specific embodiment of the present application does not limit example embodiments of the information communication apparatus 900. As shown in FIG. 9, the information communication apparatus 900 may comprise:

a processor 910, a communications interface 920, a memory 930, and a communications bus 940.

The processor 910, the communications interface 920, and the memory 930 accomplish mutual communications via the communications bus 940.

The communications interface 920 is configured to communicate with, for example, a terminal, a third-party device, an information source or the like.

The processor 910 is configured to execute a program 932, and specifically, can implement relevant steps in any one of the forgoing information communication method embodiments.

Specifically, the program 932 may comprise a program code, the program code comprising a computer operation instruction.

The processor 910 may be a central processing unit (CPU), or an application specific integrated circuit (ASIC), or be configured to be one or more integrated circuits which implement the embodiments of the present application.

The memory 930 is configured to store the program 932. The memory 930 may comprise a high-speed RAM memory, and may also comprise a non-volatile memory, for example, at least one magnetic disk memory.

For example, in one example embodiment, the processor 910 may execute the following steps by executing the program 932: acquiring scenario description information, regularity information of execution of a terminal application and intent data of execution of the terminal application; and sending the acquired intent data to a terminal in a situation that the scenario description information matches corresponding information in the regularity information. In other example embodiments, the processor 910 may also execute the steps mentioned in any other embodiments described above by executing the program 932, which is not repeated herein.

Reference can be made to the corresponding description in the corresponding steps, modules, sub-modules and units in the foregoing example embodiments for implementation of each step in the program 932, which is not repeated herein. Those skilled in the art can clearly understand that, reference can be made to the corresponding process description in the method embodiments for the devices described above and the specific working procedures of the modules, and will not be repeated herein in order to make the description convenient and concise.

FIG. 10 is a schematic architectural diagram of one information communication system according to an embodiment of the present application. As shown in FIG. 10, one information communication system according to this embodiment of the present application comprises: a terminal 100 and an information communication apparatus 101, wherein, the information communication apparatus 101 is configured to provide intent data required by execution of the terminal application in a situation that the information communication apparatus 101 is in a communication connection with the terminal 100. The manner in which the information communication apparatus achieves a communication connection with the terminal may comprise, but is not limited to, wireless or wired manners, which is not limited in the present application. Reference can be made to FIG. 3 to FIG. 9 and the literal description in the foregoing method and apparatus embodiments for the description about the schematic structural diagram of the information communication apparatus 101, the working procedure, possible manifestations of device entities, and interaction methods of the information communication apparatus and the terminal, which are not repeated herein.

In the information communication system according to this embodiment, the information communication apparatus acquires scenario description information, regularity information of execution of a terminal application and intent data of execution of the terminal application and performs matching analysis on the scenario description information and the regularity information, and the information communication apparatus actively sends the intent data required by execution of the terminal application to a terminal in a situation that their corresponding information matches each other and the information communication apparatus is in a communication connection with the terminal, which thus simplifies or eliminates tedious operations performed by users for acquiring intent data, can targetedly provide the intent data according to different scenario description information and regularity information of execution of different applications, can better meet demands of the users, has good timeliness, and improves user experience.

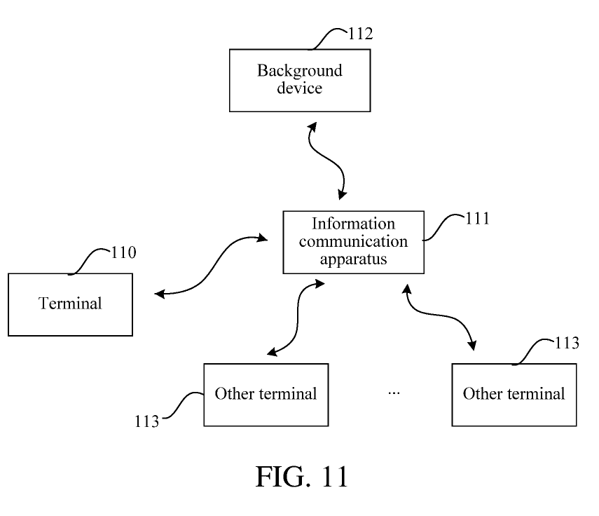

FIG. 11 is a schematic architectural diagram of another information communication system according to an embodiment of the present application. As shown in FIG. 11, the information communication system according to this embodiment of the present application comprises: a terminal 110, an information communication apparatus 111 and a background device 112. In a situation that the background device 112 is configured to provide intent data for the information communication apparatus 111 in a situation of being in a communication connection with the information communication apparatus 111. The information communication apparatus 111 is configured to provide intent data required by execution of the terminal application in a situation of being in a communication connection with the terminal 110. The manners in which the background device and the information communication apparatus achieve a communication connection and the information communication apparatus and the terminal achieve a communication connection may comprise, but are not limited to, wireless and wired manners, which are not limited in the present application. Reference can be made to FIG. 3 to FIG. 9 and the literal description in the foregoing method and apparatus embodiments for the description about the schematic structural diagram of the information communication apparatus 111, the working procedure, possible manifestations of device entities, and interaction methods of the information communication apparatus and the terminal, which are not repeated herein. The background device 112 may be a certain remote server, or belongs to another device in the same LAN with the information communication apparatus, or a certain third-party device, or the like, which is not limited in the present application.

In the information communication system according to this embodiment, the information communication apparatus acquires scenario description information, regularity information of execution of a terminal application and intent data of execution of the terminal application and performs matching analysis on the scenario description information and the regularity information, and the information communication apparatus actively sends the intent data required by execution of the terminal application to a terminal in a situation that their corresponding information matches each other and the information communication apparatus is in a communication connection with the terminal, which thus simplifies or eliminates tedious operations performed by users for acquiring intent data, can targetedly provide the intent data according to different scenario description information and regularity information of execution of different applications, can better meet demands of the users, has good timeliness, and improves user experience.

On the basis of the technical solution of any one information communication system embodiment of the present application, the information communication system may further comprise: at least one other terminal 113. The at least one other terminal 113 is respectively in a communication connection with the information communication apparatus; the information communication apparatus further sending the intent data to the at least one other terminal in a situation of sending the intent data to the terminal. In this situation, that a plurality of associated terminals share intent data can be achieved, and tedious operations of acquiring the intent data repeatedly by other terminals are eliminated.

In the following, it might as well give further description by taking applications of the technical solution of the present application in a smart home as an example, and apparently, the scenario should not be understood as a limitation to the technical solution of the present application. Suppose that a certain home LAN comprises a home gateway, there are a plurality of terminals accessed to the home gateway, and each terminal communicates with a device outside the LAN via the home gateway. In the application scenario, the home gateway plays a role of the information communication apparatus in the present application, the home gateway acquires scenario description information, regularity information of execution of a terminal application and intent data of execution of the terminal application, and sends the acquired intent data to a terminal in a situation that the scenario description information matches corresponding information in the regularity information. For example, the regularity information obtained by the home gateway through statistical analysis is: a certain terminal is always executing a certain application of weather conditions in a position of an elevator waiting zone at the door at 8:00 a.m., to obtain weather condition information of the day. Then, the home gateway can acquire the scenario description information by monitoring position information and current time information of the terminal. If monitoring that the terminal is in the elevator waiting zone at the door at 8:00 a.m., the home gateway can actively send intent data such as weather conditions to the terminal; the home gateway combines scenarios and regularity information of execution of terminal applications to intelligently send information in such a manner that user information will be acquired more conveniently, the data sent will be more consistent with user demands, and timeliness is higher.

In the various embodiments of the present application, the serial numbers and/or sequence numbers of the foregoing embodiments are merely for the convenience of description, and do not imply the preference among the embodiments. Particular emphasis on is put on the description about each embodiment, and reference can be made to relevant description of other embodiments for the content not detailed in a certain embodiment.

It can be appreciated by those of ordinary skill in the art that each exemplary unit and method step described with reference to the embodiments disclosed herein can be implemented by electronic hardware or a combination of computer software and electronic hardware. Whether these functions are executed in a hardware mode or a software mode depends on particular applications and design constraint conditions of the technical solution. The professional technicians can use different methods to implement the functions described with respect to each particular application, but such implementation should not be considered to go beyond the scope of the present application.

If the functions are implemented in the form of a software functional unit and is sold or used as an independent product, it can be stored in a computer-readable storage medium. Based on such understanding, the technical solution of the present application essentially or the part which contributes to the prior art or a part of the technical solution can be embodied in the form of a software product, and the computer software product is stored in a storage medium, and comprises several instructions for enabling a computer device (which can be a personal computer, a server, or a network device, and the like) to execute all or some steps of the method described in each embodiment of the present application. The foregoing storage medium comprises, a USB disk, a removable hard disk, a read-only memory (ROM), a random access memory (RAM), a magnetic disk, an optical disk or any other mediums that can be configured to store program codes.

In the embodiments of the apparatuses, methods and systems of the present application, it is apparent that the members (systems, sub-systems, modules, sub-modules, units, sub-units, and the like) or the steps can be decomposed, combined and/or recombined after decomposition. The decomposition and/or recombination should be regarded as equivalent solutions of the present application. Moreover, in the description about the embodiments of the present application, features described and/or illustrated with respect to an implementation may be used in one or more other example embodiments in the same or a similar manner, be combined with features in other example embodiments, or replace the features in other example embodiments.

It should be emphasized that, the term “comprise” used herein refers to existence of features, elements, steps or components, but does not exclude existence or addition of one or more other features, elements, steps or components.

Finally, it should be noted that, the above example embodiments are only intended to describe the present application rather than to limit the present application; various changes and variations can be made by those of ordinary skill in the art without departing from the spirit and scope of the present application, so all equivalent technical solutions also belong to the category of the present application, and the scope of patent protection of the present application should be defined by the claims.

What is claimed is:

1. A method, comprising:
acquiring, by a system comprising a processor, scenario description information, regularity information of execution of a terminal application and intent data of the execution of the terminal application; and
sending the intent data to a terminal in a situation that the scenario description information matches corresponding information in the regularity information.

2. The method of claim 1, wherein the scenario description information comprises at least one of current time information, and current position information of the terminal.

3. The method of claim 1, wherein the regularity information comprises at least one of time information of the execution of the terminal application, and position information of the terminal during the execution of the terminal application.

4. The method of claim 1, wherein the acquiring the regularity information of the execution of the terminal application comprises:
forming a statistical result from information of the execution of the terminal application; and
acquiring the regularity information according to the statistical result.

5. The method of claim 4, wherein the forming the statistical result from the information of the execution of the terminal application comprises:
receiving a data message, sent by the terminal, comprising data that enables acquisition of the intent data of the execution of the terminal application; and
forming the statistical result from the information of the execution according to the data message.

6. The method of claim 1, wherein the acquiring the regularity information of the execution of the terminal application comprises:
acquiring the regularity information from an external device.

7. The method of claim 1, wherein the acquiring the intent data of the execution of the terminal application comprises:
acquiring the intent data of the execution of the terminal application from an external device.

8. The method of claim 1, wherein the acquiring the intent data of the execution of the terminal application comprises:
determining an information source of the intent data of the execution of the terminal application; and
acquiring the intent data from the information source.

9. The method of claim 8, wherein the determining the information source of the intent data of the execution of the terminal application comprises:
receiving a data message, sent by the terminal, comprising data that enables acquisition of the intent data of the execution of the terminal application; and
obtaining the information source of the intent data obtained by the terminal according to the data message.

10. The method of claim 1, further comprising, before the sending the intent data to the terminal:
determining whether to send the intent data to the terminal according to at least one preset judgment condition.

11. The method of claim 10, wherein the at least one preset judgment condition comprises at least one of:
whether the intent data satisfies a pre-customized data filter condition; or
whether the terminal is currently in a preset call state.

12. The method of claim 1, further comprising:
determining characteristic information of the terminal application; and
sending the characteristic information of the terminal application to the terminal.

13. The method of claim 1, further comprising:
determining at least one other terminal associated with the terminal; and
sending the intent data to the at least one other terminal.

14. An apparatus, comprising:
a memory that stores executable modules; and
a processor, coupled to the memory, that executes or facilitates execution of the executable modules, comprising:
a scenario description information acquisition module configured to receive scenario description information;
a regularity information acquisition module configured to receive regularity information of execution of a terminal application;
an intent data acquisition module configured to receive intent data of the execution of the terminal application; and
an information sending module configured to send the intent data received by the intent data acquisition module to the terminal in response to the scenario description information received by the scenario description information acquisition module being determined to match corresponding information in the regularity information received by the regularity information acquisition module.

15. The apparatus of claim 14, wherein the scenario description information comprises at least one of current time information, or current position information of the terminal.

16. The apparatus of claim 14, wherein the regularity information comprises at least one of time information of the execution of the terminal application, and position information of the terminal during the execution of the terminal application.

17. The apparatus of claim 14, wherein the regularity information acquisition module comprises:
a statistics sub-module configured to determine a statistic based on information of the execution of the terminal application; and
a first regularity information acquisition sub-module configured to receive the regularity information according to the statistic.

18. The apparatus of claim 17, wherein the statistics sub-module comprises:
a statistics unit configured to determine a statistic on the information of the execution according to a received data message, sent by the terminal, comprising data that enables reception of the intent data of the execution of the terminal application.

19. The apparatus of claim 14, wherein the regularity information acquisition module comprises:
a second regularity information acquisition sub-module configured to receive the regularity information from an external device.

20. The apparatus of claim 14, wherein the intent data acquisition module comprises:
a first intent data acquisition sub-module configured to receive the intent data of the execution of the terminal application from an external device.

21. The apparatus of claim 14, wherein the intent data acquisition module comprises:
an information source determination sub-module configured to determine an information source of the intent data of the execution of the terminal application; and
a second intent data acquisition sub-module configured to receive the intent data from the information source determined by the information source determination sub-module.

22. The apparatus of claim 21, wherein the information source determination sub-module comprises:
an information source determination unit configured to obtain the information source of the intent data obtained by the terminal according to a received data message, sent by the terminal, comprising data that enables reception of the intent data of the execution of the terminal application.

23. The apparatus of claim 14, wherein the executable modules further comprise:
a determination module configured to determine whether to send the intent data to the terminal according to a preset judgment condition; and
an enable module configured to enable the information sending module according to a determination result of the determination module according to a preset judgment condition.

24. The apparatus of claim 23, wherein the determination module comprises at least one of:
a first determination sub-module configured to determine whether the intent data received by the intent data acquisition module satisfies a pre-customized data filter condition; and
a second determination sub-module configured to determine whether the terminal is currently in a preset call state,
wherein the enable module comprises an enable sub-module configured to enable the information sending module according to a judgment result of the first determination sub-module or the second determination sub-module.

25. The apparatus of claim 14, wherein
the executable modules further comprise: an application characteristic information determination module configured to determine characteristic information of the terminal application, and wherein
the information sending module is further configured to send the characteristic information of the terminal application to the terminal concurrently with sending the intent data to the terminal.

26. The apparatus of claim 14, wherein
the executable modules further comprise: an associated terminal information determination module configured to determine at least one other terminal associated with the terminal; and
the information sending module comprises:
a first information sending sub-module configured to send the intent data to the terminal in response to the scenario description information being determined to match the corresponding information in the regularity information; and
a second information sending sub-module configured to send the intent data to the at least one other terminal determined by the associated terminal information determination module in response to the scenario description information being determined to match the corresponding information in the regularity information.

27. A system, comprising: a terminal and the apparatus of claim 14, the apparatus being configured to provide intent data required by execution of the terminal application in response to the apparatus being determined to be in a communication connection with the terminal.

28. The system of claim 27, further comprising:
a background device, configured to provide the regulation information of the execution or the intent data for the apparatus in response to being determined to be in a communication connection with the apparatus.

29. The system of claim 27, further comprising:
at least one other terminal, respectively in a communication connection with the apparatus; the apparatus further sending the intent data to the at least one other terminal in response to sending the intent data to the terminal.

30. A computer readable storage apparatus, comprising at least one executable instruction, which, in response to execution, causes an apparatus comprising a processor to perform operations, comprising:
acquiring scenario description information, regularity information of execution of an application of another apparatus and intent data of the execution of the application; and
sending the intent data to the other apparatus in a situation that the scenario description information matches corresponding information in the regularity information.

31. An apparatus, characterized by comprising a processor and a memory, the memory storing executable instructions, the processor being connected to the memory through a communication bus, and when the apparatus for controlling task migration operates, the processor executes or facilitates executing the executable instructions stored in the memory, so that the apparatus for controlling the task migration executes operations, comprising:
acquiring scenario description information, regularity information of execution of a terminal application and intent data of the execution of the terminal application; and
sending the intent data to a terminal in a situation that the scenario description information is determined to match corresponding information in the regularity information.
